(19) United States
(12) Patent Application Publication
(10) Pub. No.: US 2010/0142213 A1
(43) Pub. Date: Jun. 10, 2010

(54) Methods And Apparatus For Enhancing Portable Worklight Features

(75) Inventors: William J. Bigge, Newman, GA (US); Chris Ladewig, Fayetteville, GA (US); Donald Dahl, Lawrenceville, GA (US)

Correspondence Address: KING & SPALDING, LLP, 1100 LOUISIANA ST., STE. 4000, ATTN.: IP Docketing, HOUSTON, TX, 77002-5213, US

(73) Assignee: COOPER TECHNOLOGIES COMPANY, Houston, TX (US)

(21) Appl. No.: 12/571,179

(22) Filed: Sep. 30, 2009

Related U.S. Application Data
(60) Provisional application No. 61/101,408, filed on Sep. 30, 2008.

(51) Int. Cl. F21S 8/08; F21S 8/00

(52) U.S. Cl. 362/413; 362/410; 362/430

(57) ABSTRACT

Portable worklight assemblies and mounting systems for worklight heads are provided. The worklight assemblies allow for greater adjustability of individual portable worklight heads along all three axis. The worklight assemblies also provide configurations that allow for the removal of a single portable worklight head from a dual-head worklight assembly. The mounting system also provides for additional power consumption needs by providing electrical receptacles that are incorporated into worklight stands or tripod-style stands used in conjunction with worklights. Providing extra receptacles and/or allowing for the removal of individual worklights based on specific positioning needs reduces the amount of equipment needed, thereby reducing clutter and increasing safety in the work area.

### CROSS-REFERENCE TO RELATED APPLICATIONS

The present application claims priority to U.S. Provisional Patent Application No. 61/101,408, titled “Methods And Apparatus For Enhancing A Portable Worklight Fixture,” filed on Sep. 30, 2008. The entire disclosure of the provisional patent application is incorporated herein by reference.

### TECHNICAL FIELD

The present application is directed to portable worklights. More specifically, the present application is directed to systems and methods for enhancing portable worklight assemblies.

### BACKGROUND OF THE INVENTION

Workers at a worksite often require multiple outlets for their power tools. This results in the presence of multiple line splitters and extension cords at the worksite, thus causing clutter at the worksite and creating a potential unsafe environment. In addition, portable worklight assemblies are generally used at worksites to provide lighting in work areas requiring illumination. Most conventional worklight assemblies have a number of disadvantages however. For example, some worklight assemblies must be tilted or entirely moved if a worker wants to aim the light in a desired direction. Most conventional worklight assemblies includes a series of knobs which are loosened to move the worklight head position, then tightened again once the worklight head is in position. Other conventional worklight assemblies rely on an detent-indexing method that eliminates adjusting knobs and instead consists of detents spaced at angular intervals. Unfortunately, these methods limit worklight head movement to a rotational movement within orthogonal planes (horizontal, vertical, or both). In addition, some worklight assemblies can take up a large amount of space.

Therefore, a need exists for an improved worklight assembly that can eliminate the disadvantages of conventional worklight assemblies.

### SUMMARY OF THE INVENTION

The present invention attempts to satisfy the above-described need by providing worklight assemblies having enhanced capabilities over conventional worklight assemblies. The worklight assemblies generally reduce clutter and improve safety, save space at a worksite, include features that allow individual worklight heads to be removed one at a time, and include mount systems that allow precise adjustment of the worklight heads over a wide range of rotation.

In one aspect of the invention, the worklight assembly includes a fixture, such as a worklight stand, coupled to a worklight head. In one aspect, the fixture is a worklight stand having a vertical shaft and multiple legs coupled to the shaft, such as a tripod. In another aspect of the invention, the worklight stand includes a horizontal mounting shaft for coupling to a worklight head, a horizontal base portion positioned below the mounting shaft, and a connector shaft coupled to the mounting shaft and base portion. The fixture includes a power strip having electrical receptacles. In some aspects, the power strip is integral to the fixture. In other aspects, the power strip is coupled to the fixture by locking collars. A power cord extends from one end of the power strip to the worklight heads, and another power cord extends from the other end of the power strip and includes a plug.

In another aspect of the invention, the worklight assembly includes a ball-type mount system. The ball-type mount system includes an outer casing having a substantially circular cross-section and an inner housing having a substantially spherical portion sized to fit within the outer casing. A locking mechanism is positioned within the inner housing. The locking mechanism includes a locking means, such as spikes, a knurled surface, a ball bearing, divots, and protrusions that engage the outer casing and lock the inner housing in place. The interior of the outer casing is configured to receive the locking means. In some aspects, the locking means include spikes or a knurled surface, and the interior of the outer casing includes a conformal coating. In other aspects, the locking means is a ball bearing, and the interior of the outer casing includes recesses configured to receive the ball bearing. In yet other aspects, the locking means include divots or protrusions, and the interior of the outer casing include a pattern corresponding to and configured to receive the divots protrusions. The locking mechanism engages the outer casing in the locked position and prevents movement of the spherical portion within the outer casing. The locking mechanism disengages the outer casing in the unlocked position and allows movement of the outer casing along the surface of the spherical portion of the inner housing.

In yet another aspect of the invention, the worklight assembly includes a hinge and yoke system. The hinge and yoke system includes a horizontally extending longitudinal bar and a handle extending orthogonally from the bar. Two flanges extend from the bar at each end of the bar. Each flange includes a hinge portion that is hingedly coupled to a mounting plate. The mounting plate is movable relative to the flange. The mounting plate is configured to be releasably coupled to a worklight head.

In yet another aspect of the invention, the worklight assembly includes a mounting assembly releasably coupled to a worklight, and a horizontally extending bar having a channel along the length of the bar. The channel is configured to receive a portion of the mounting assemblies. In one aspect, the mounting assembly is a T-slot and yoke system. The T-slot and yoke system includes a horizontally extending longitudinal bar and a handle extending orthogonally from the bar. Two first extensions extend orthogonally from each side of a flat surface of the bar along the length of the bar. Two second extensions extend orthogonally from the first extensions towards each other. The flat surface, first extensions, and second extensions form a channel for slidably receiving a mounting assembly. In certain aspects, the mounting assembly includes a washer assembly and a threaded knob. Upon tightening of the threaded knob, the washer assembly is forced against the second extensions of the channel, thus locking the mounting assembly in place. In another aspect, the mounting assembly includes a yoke system having a horizontally extending longitudinal bar and a C-shaped channel. Two first extensions extend orthogonally from each side of a flat surface of the bar along the length of the bar in a direction away from the handle. The flat surface and the first extensions form a C-shaped channel for receiving a worklight leg. The worklight leg can be rotated and locked into place within the C-shaped channel by a clamping bolt.

In yet another aspect of the invention, the worklight assembly includes multi-axis friction clutch. The multi-axis friction clutch includes a clutch housing having a cylindrical first cavity and cylindrical second cavity perpendicular to the first cavity. The first cavity includes multiple stationary disks, a rotatable disk positioned between the at least two of the stationary disks, and a compressible disk positioned adjacent one of the stationary disks and a wall of the clutch housing. A shaft extends through openings in the clutch housing, stationary disks, rotatable disk, and compressible disk. The rotatable disk is keyed to engage and move with the shaft. The compressible disk applies a holding force on the disks and prevents the rotatable disk from moving independently without the application of a force. The shaft is configured to be coupled to a worklight head. A user can apply force to overcome the holding force to move the worklight head in a vertical direction. In some aspects of the invention, the second cavity includes multiple stationary disks, a rotatable disk positioned between at least two of the two stationary disks, and a compressible disk positioned adjacent one of the stationary disks and a wall of the clutch housing. A shaft extends through openings in the stationary disks, rotatable disk, and compressible disk. The rotatable disk is keyed to engage and move with the shaft. The compressible disk applies a holding force on the disks and prevents the rotatable disk from moving from moving independently without the application of a force. The shaft is configured to be coupled to a worklight frame. A user can apply force to overcome the holding force to move the worklight head in a horizontal direction. In certain aspects of the inventions, the compressible disks may be a compressed wave washer, a Bellville washer, or a compression spring.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

The foregoing and other features and aspects of the invention may be best understood with reference to the following description of certain exemplary embodiments, when read in conjunction with the accompanying drawings as follows.

FIG. 1A is a perspective view of a combination worklight and power strip system, according to an exemplary embodiment of the present invention.

FIG. 1B is a side view of section A-A of the exemplary worklight system of FIG. 1A.

FIG. 2A is a front elevational view of an alternative combination worklight and power strip system, according to an exemplary embodiment of the present invention.

FIG. 2B is a right side elevational view of section A-A of the exemplary worklight system of FIG. 2A.

FIG. 2C is a left side elevational view of section A-A of the exemplary worklight system of FIG. 2A.

FIG. 2D is a cross-sectional view of section B-B of the exemplary worklight system of FIG. 2A.

FIG. 2E is a front view of section C-C of the exemplary worklight system of FIG. 2A.

FIG. 2F is a front elevational view of section D-D of the worklight system of FIG. 2A, presenting caps on a power strip in the closed position.

FIG. 2G is a front elevational view of section A-A of the exemplary power strip of FIG. 2F, presenting the cap on the power strip in the open position.

FIG. 2H is a side view of section A-A of the exemplary power strip of FIG. 2F, presenting the cap on the power strip in the open position.

FIG. 3 is a front elevational view of yet another combination worklight and power strip system, according to an exemplary embodiment of the present invention.

FIG. 4A is an exploded view showing components of a ball-type mount system for a worklight assembly, according to an exemplary embodiment of the present invention.

FIG. 4B is a perspective view of the exemplary ball-type mount system of FIG. 4A, in an assembled state, with an outer ball assembly removed.

FIG. 4C is a cross-sectional view of the exemplary ball-type mount system of FIG. 4B, in the locked position.

FIG. 4D is a cross-sectional view of the exemplary ball-type mount system of FIG. 4B, in the unlocked position.

FIG. 5 is a cross-sectional view of another ball-type mount system for a worklight assembly, according to an exemplary embodiment of the present invention.

FIG. 6 is a cross-sectional view of still another ball-type mount system for a worklight assembly, according to an exemplary embodiment of the present invention.

FIG. 7A is a perspective view of a hinge and yoke system for a worklight assembly, according to an exemplary embodiment of the present invention.

FIG. 7B is a perspective view of the exemplary hinge and yoke system of FIG. 7A, coupled to two worklight heads.

FIG. 7C is a perspective view of the exemplary hinge and yoke system coupled of FIG. 7B, coupled to a tripod, according to an exemplary embodiment of the present invention.

FIG. 7D is a perspective view of the exemplary hinge and yoke system of FIG. 7C, according to another exemplary embodiment of the present invention.

FIG. 7E is a perspective view of the exemplary hinge and yoke system of FIG. 7C, according to yet another exemplary embodiment of the present invention.

FIG. 8A is a perspective view of a T-slot lock and yoke system for a worklight assembly, according to an exemplary embodiment of the present invention.

FIG. 8B is a perspective view of the T-slot lock and yoke system of FIG. 8A coupled to two worklight assemblies, according to an exemplary embodiment of the present invention.

FIG. 8C is a perspective view of the exemplary T-slot lock and yoke system of FIG. 8B, coupled to a tripod, according to an exemplary embodiment. of the present invention

FIG. 8D is a perspective view of the exemplary T-slot lock and yoke system of FIG. 8C, according to an exemplary embodiment of the present invention.

FIG. 9A is an exploded view of a multi-axis friction clutch for a worklight assembly, according to an exemplary embodiment of the present invention.

FIG. 9B is a cross-sectional assembly view of the exemplary multi-axis friction clutch of FIG. 9A.

FIG. 9C is a back perspective view of an exemplary worklight head coupled to the multi-axis friction clutch shown in FIG. 9A, according to one exemplary embodiment of the present invention.

FIG. 10A is a perspective view of a worklight assembly having rotatable legs, according to an exemplary embodiment of the present invention.

FIG. 10B is a cross-sectional view of section A-A of the exemplary worklight assembly of FIG. 10A.

FIG. 10C is a perspective view of the worklight assembly of FIG. 10A, mounted to a tripod with the legs in a folded position.

### DETAILED DESCRIPTION OF THE INVENTION

Portable worklight assemblies described herein have enhanced capabilities over conventional worklight assemblies. Some of the embodiments described reduce clutter and save space at the worksite. Other embodiments allow a user to adjust the direction of a worklight head as desired with more precision and over an increased range of rotation over conventional worklight assemblies. Yet other embodiments allow a user to remove one individual worklight head at a time if needed for replacement, thus eliminating the need for replacing an entire worklight assembly if one worklight head malfunctions.

The invention may be better understood by reading the following description of non-limitative, exemplary embodiments with reference to the attached drawings wherein like parts of each of the figures are identified by the same reference characters.

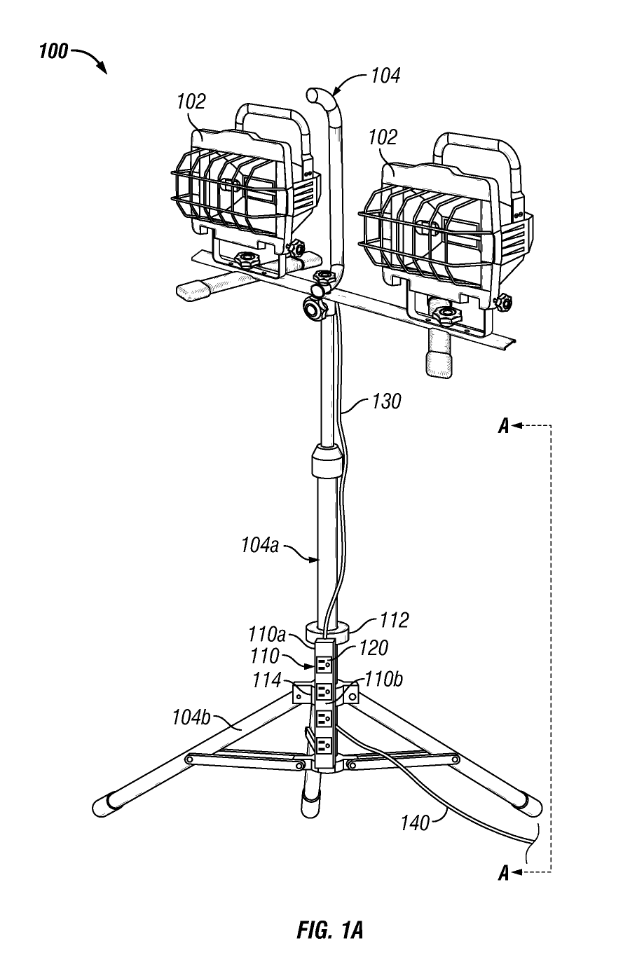

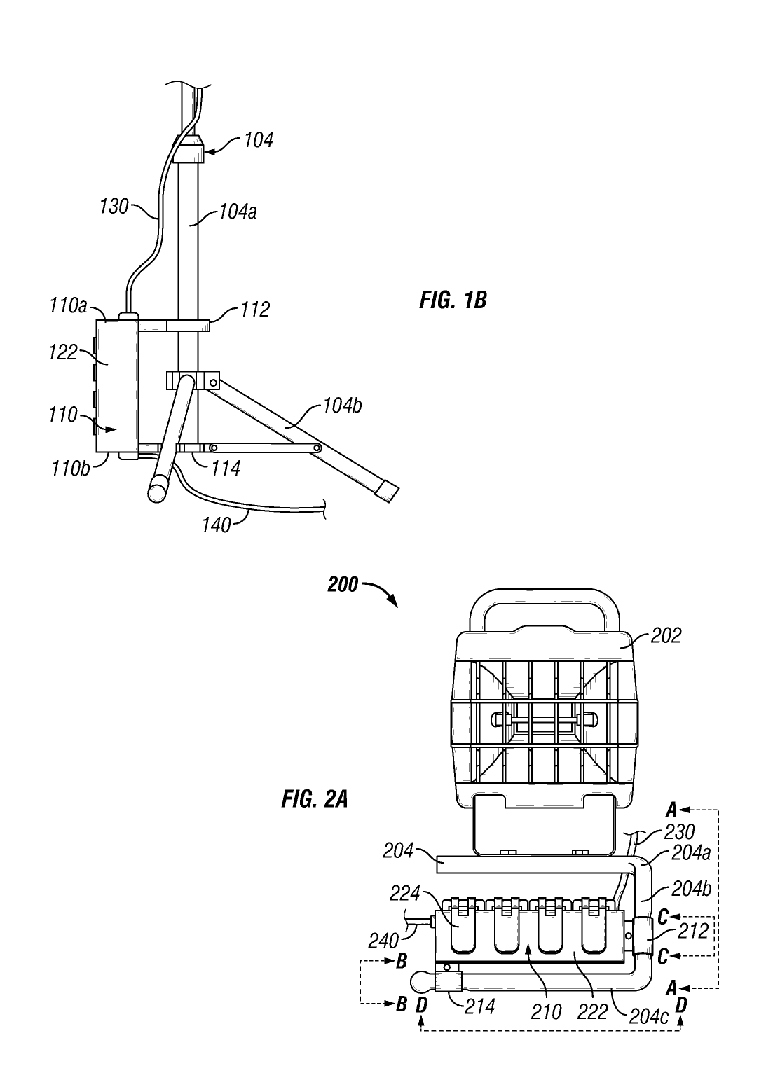

FIG. 1A is a perspective view of a worklight system 100, according to an exemplary embodiment. FIG. 1B is a side view of a section A-A of the exemplary worklight system 100 of FIG. 1A. Referring now to FIGS. 1A and 1B, the exemplary worklight system 100 includes two worklight heads 102 for providing lighting to a work area (not shown). Each of the worklight heads 102 are detachably mounted to a worklight tripod 104. In some embodiments, the worklight heads 102 are mounted to the worklight tripod 104 by a yoke system and threaded knobs. In one exemplary embodiment, each worklight head 102 includes a worklight housing having an open end, a lamp disposed within the worklight housing and a protective cage positioned along the open end of the worklight housing. The protective cage is typically adjustable from an open configuration, that provides access to the open end of the worklight housing, to a closed configuration, that limits some access to the open end of the worklight housing from an exterior of the housing.

A power strip 110 is coupled to the tripod 104 by a moving collar 112 and a tripod leg mount 114. The moving collar 112 is fixed to a first end 110a of the power strip 110 and is movably coupled around a shaft 104a of the tripod 104. The tripod leg mount 114 is fixed to a second end 110b of the power strip 110 and is fixedly coupled to the shaft 104a at a position below legs 104b of the tripod 104. The moving collar 112 aids in stabilizing the power strip 110 along the shaft 104a of the tripod 104 to reduce the chance of tripod tip-over, and slides along the shaft 104a when the tripod 104 is collapsed for storage.

The exemplary power strip 110 includes four plug receptacles 120 aligned linearly adjacent to one another, and housed within a casing 122. In certain alternative embodiments, the power strip 110 includes six plug receptacles 120 configured in one row of six or two rows of three. In other alternative embodiments, the power strip 110 includes eight plug receptacles 120 configured in one row of eight or two rows of four. One having ordinary skill in the art will recognize that any number of plug receptacles 120 may be included in the power strip 110, and arranged in a number of configurations. While the plug receptacles 120 shown in FIG. 1A are compatible with a standard U.S. plug, one having ordinary skill in the art will recognize that the plug receptacles 120 can be shaped and arranged in any suitable manner to accommodate the shape and arrangement of contact and ground pins of a desired plug to be coupled therewith.

A first cable 130 is electrically coupled to the power strip 110 at the first end 110a, and a second cable 140 is electrically coupled to the power strip 110 at the second end 110b. The first cable 130 extends from the first end 110a of the power strip 110 to power the worklight heads 102. In certain exemplary embodiments, the first cable 130 extends from the first end 110a of the power strip 110 to a Y-junction and then splits off to each of the worklight heads 102. The second cable 140 includes a plug (not shown) and extends from the second end 110b of the power strip 110 to a wall receptacle (not shown) for power. When the plug of the second cable 140 is inserted into a receptacle providing power, power is supplied to the worklight system 100. Additional power tools (not shown) adjacent to the area where work is being undertaken are capable of being plugged into the power strip 110 for powering these tools. As a result, the present configuration decreases clutter and provides improved safety around the worksite by eliminating the need for a separate, unsecured power strip to be used in conjunction with the worklights and tripod stand.

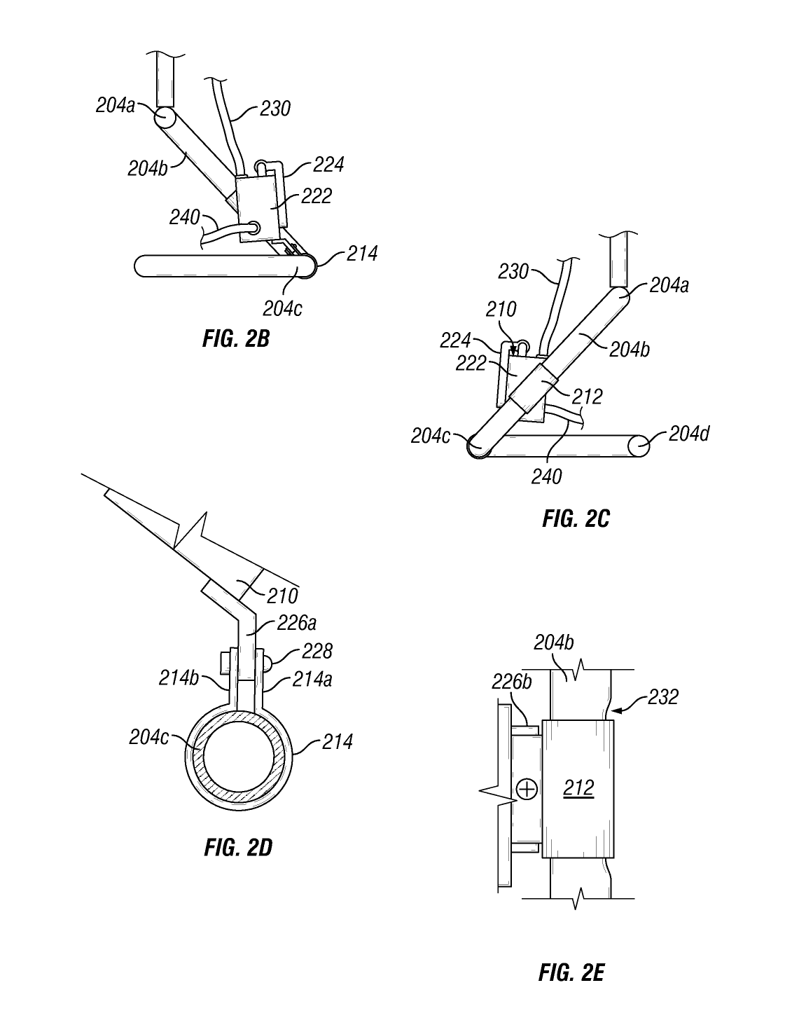

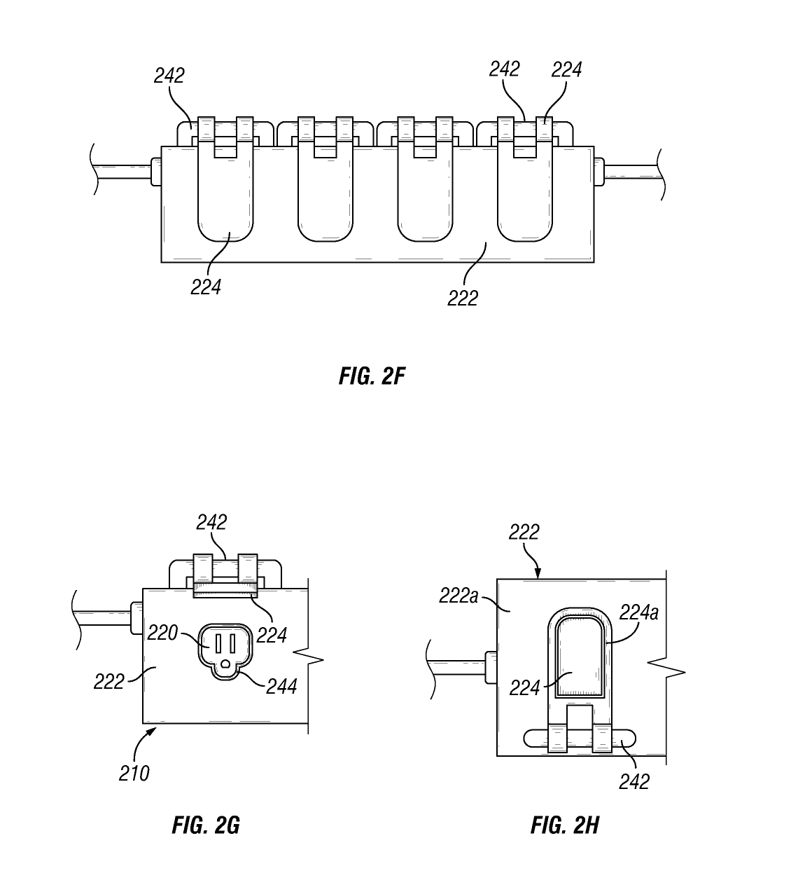

FIGS. 2A-2C are different view an alternative worklight system 200, according to another exemplary embodiment of the present invention. Now referring to FIGS. 2A-2C, the worklight system 200 includes a worklight head 202 that provides lighting to a work area. The worklight head 202 is mounted to a top portion 204a of a stand 204. From the horizontally aligned top portion 204a of the stand 204 extends a middle portion 204b at an angle of about 45 degrees downward towards a base portion 204c. In one exemplary embodiment, the base portion 204c is U-shaped, with the free end 204d of the base portion 204c being aligned with the top portion 204a; however, bases of other shapes are within the spirit and scope of this invention.

A power strip 210 is coupled to the stand 204 by collars 212 and 214. The collar 212 is coupled to a first end 210a of the power strip 210 and around the middle portion 204b of the stand 204. The collar 214 is coupled to a second end 210b of the power strip 210 and around the base portion 204c of the stand 204. In certain alternative exemplary embodiments, the collars 212, 214 are coupled to the top portion 104a of the stand 104. In one exemplary embodiment, the power strip 210 includes four plug receptacles 220, as shown in FIG. 2G, aligned linearly adjacent to one another, and housed within a casing 222. One having ordinary skill in the art will recognize that any number of plug receptacles 220 may be included in the power strip 210, and arranged in a number of configurations. The power strip 210 includes a corresponding number of caps 224 for covering the plug receptacles 220.

A first cable 230 is electrically coupled to the power strip 210 at the first end 210a, and a second cable 240 is electrically coupled to the power strip 210 at the second end 210b. The first cable 230 extends from the first end 210a of the power strip 210 to power the worklight head 202. The second cable 240 includes a plug (not shown) and extends from the second end 210b of the power strip 210 to a wall receptacle (not shown) for power. When the plug of the second cable 240 is inserted into a receptacle providing power, power is supplied to the worklight system 200. Additional power tools adjacent to the area where work is being undertaken are plugged into the power strip 210 and power is supplied to these tools through the power strip 210. As a result, the present configuration decreases clutter and provides improved safety around the worksite by eliminating the need for a separate, unsecured power strip 210 to be used in conjunction with the worklights and tripod stand.

FIG. 2D is a cross-sectional view of section B-B of the exemplary worklight system 200 of FIG. 2A. FIG. 2E is a front view of section C-C of the exemplary worklight system 200 of FIG. 2A. FIG. 2F is a front elevational view of section D-D of the worklight system 200 of FIG. 2A. FIG. 2G is a front elevational view of a section A-A of the power strip 210 of FIG. 2F. FIG. 2H is a side view of the section A-A of the power strip 210 of FIG. 2F. Referring now to FIGS. 2D-2H, the exemplary collar 214 is substantially circular with an opening from which two extensions 214a, 214b extend. A flange 226a is positioned between the two extensions 214a, 214b and a screw 228 extends through openings (not shown) in the extensions 214a, 214b and the flange 226a to secure the power strip 210 to the collar 214. In FIG. 2E, the collar 212 is substantially similar to the collar 214, of FIG. 2D, and is coupled to the stand 204 in the same or substantially similar manner. The stand 204 includes a recess 232. The recess 232 provides clearance between the collar 212 for the power strip 210 and support stand 204 on which the worklight head 202 rests.

The exemplary power strip 210 further includes four caps 224. Each cap 224 is capable of covering at least one of the plug receptacles 220 that are housed within the casing 222. In one exemplary embodiment, the caps 224 are pivotally mounted to the power strip 210 by hinges 242. The hinges 242 are fixedly coupled to the casing 222 of the power strip 210. The cap 224 swings back along the hinge 242 to a side of the casing 222, and allows access to the plug receptacle 220. In certain exemplary embodiments, the plug receptacle 220 is surrounded by a rubber seal 244 that seals a plug upon insertion into the plug receptacle 220 and prevents water entry into the plug receptacle 220. As shown in FIG. 2H, the exemplary cap 224 swings back along the hinge 242 to a side 222a of the casing 222. In one exemplary embodiment, the cap 224 includes a silicone seal 224a that seals the plug receptacle 220 when the cap 224 is in the closed position, and prevents water entry to the plug receptacle 220.

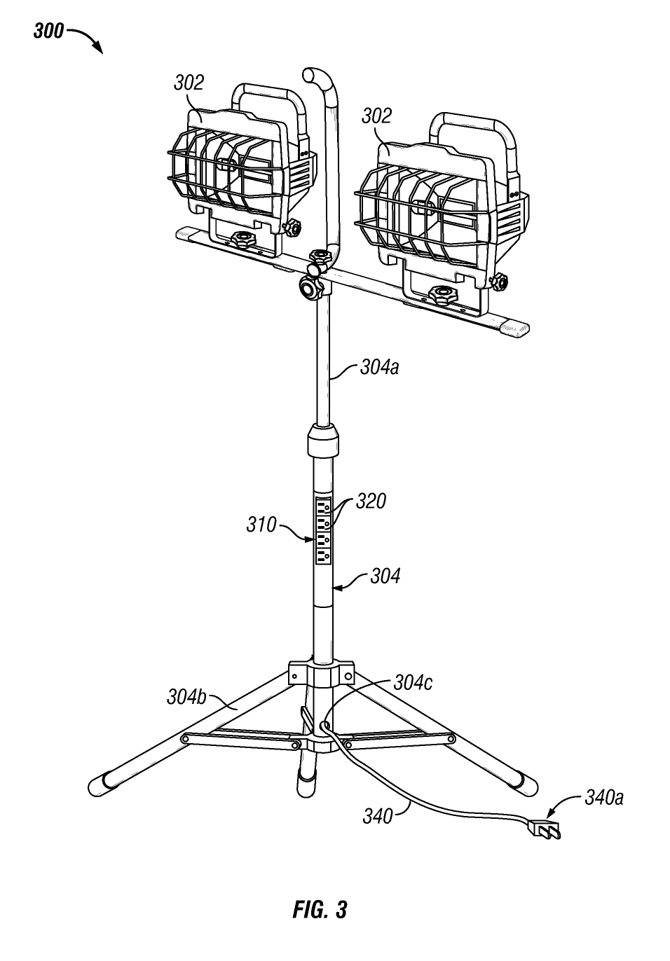

FIG. 3 is a front elevational view of yet another alternative worklight system 300, according to another exemplary embodiment of the present invention. Turning now to FIG. 3, the exemplary worklight system 300 includes two worklight heads 302 for providing lighting to a work area (not shown). Each of the worklight heads 302 are detachably mounted to a worklight tripod 304. A power strip 310 is integrally mounted within a shaft 304a of the tripod 304. In one exemplary embodiment, the power strip 310 includes four plug receptacles 320 aligned linearly adjacent to one another. Alternatively, one having ordinary skill in the art will recognize that any number and configuration of plug receptacles 320 are within the scope and spirit of this invention and may be included in the power strip 310. While the exemplary plug receptacles 320 shown are compatible with a standard U.S. plug, one having ordinary skill in the art will recognize that the plug receptacles 320 can be shaped and arranged in any suitable manner to accommodate the shape and arrangement of contact and ground pins of a desired plug to be used.

A cable 340 is electrically coupled to the power strip 310 within the shaft 304a. The cable 340 extends from the shaft 304a to an exterior via an opening 304c in the shaft 304a proximate the tripod legs 304b. In certain exemplary embodiments, the cable 340 is retractable. The cable 340 includes a plug 340a configured to be inserted into a wall receptacle (not shown) for power. When the plug 340a is inserted into the wall receptacle, power is supplied to the worklight system 300. Additional power tools adjacent to the area where work is being undertaken are plugged into the power strip 310 for powering these tools. As a result, the present configuration decreases clutter and provides improved safety around the worksite.

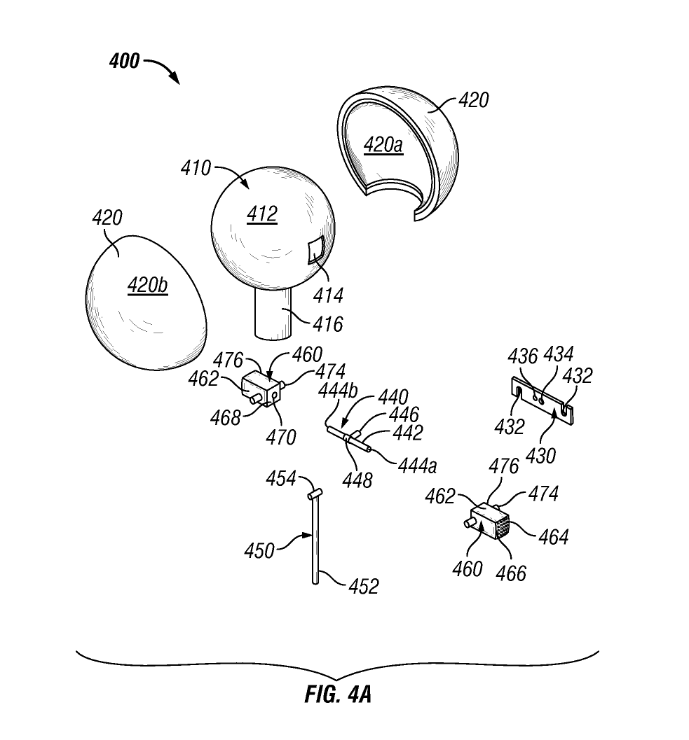

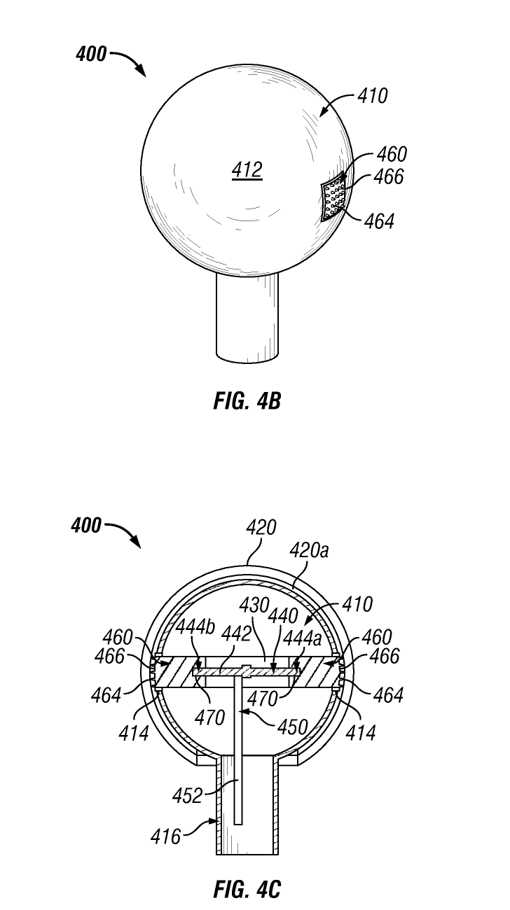

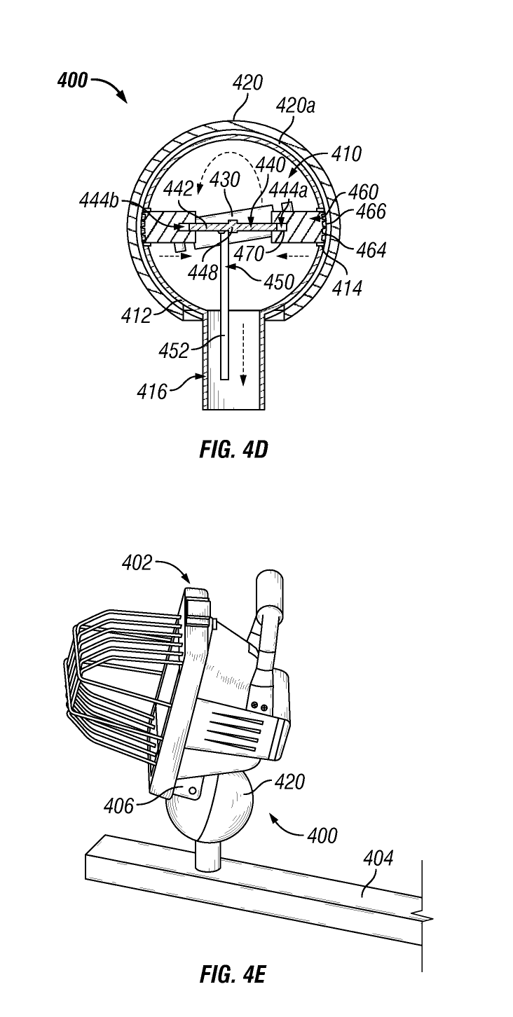

FIGS. 4A-4D are several views of a ball-type mount system 400, according to an exemplary embodiment of the present invention. Now referring to FIGS. 4A-4D, the exemplary ball-type mount system 400 includes a hollow inner ball 410. In certain exemplary embodiments, the inner ball 410 is constructed from a rigid material, such as plastic or a metal. The inner ball 410 includes a spherical portion 412 and two substantially square-shaped openings 414 positioned opposite one another on the spherical portion 412. In certain alternative embodiments, the openings 414 can have any other shape, such as a circle, triangle, hexagon, and any other geometric shape. In certain embodiments, the openings 414 may be asymmetric. One having ordinary skill in the art will recognize that the openings 414 can be configured any number of ways. The inner ball 410 also includes a hollow cylindrical protrusion 416 extending orthogonally, or substantially orthogonally, outward from the inner ball 410 at a position between the openings 414.

The ball-type mount system 400 also includes a hollow outer ball assembly 420 sized to fit over the inner ball 410. In certain exemplary embodiments, the outer ball assembly 420 includes two halves coupled together. In certain embodiments, the two halves of the outer ball assembly 420 are secured together by recessed fasteners. The outer ball assembly 420 includes a conformal coating, such as rubber or other elastomeric material, on an interior 420a of the outer ball assembly 420. In certain exemplary embodiments, the exterior 420b of the outer ball assembly 420 is constructed from a rigid material, such as plastic or a metal. In certain alternative embodiments, the interior 420a of the outer ball assembly 420 includes a series of divots (not shown) configured to receive corresponding divots (not shown) or knob-like protrusions (not shown) on spike plungers 460. Each half of the outer ball assembly 420 includes a semi-circular opening sized to fit around the cylindrical protrusion 416 of the inner ball 410.

The ball-type mount system 400 also includes a plunger lever 430 configured to engage a slide rod 440, a slide pin 450, and two spike plungers 460. In one exemplary embodiment, the plunger lever 430 is rectangular-shaped and includes U-shaped notches 432 positioned opposite one another proximate to each end of the plunger lever 430; however plunger levers 430 having other geometric and non-geometric shapes, such as a square or a circle, are within the scope of this invention. The plunger lever 430 also includes an aperture 434 positioned substantially in the center of the plunger lever 430. The plunger lever 430 further includes an aperture 436 positioned adjacent the aperture 434.

The slide rod 440 includes a cylindrical base 442 having a first end 444a and a second end 444b, and an extension 446 extending from a center 448 of the base 442. The extension 446 is sized to fit within the aperture 434 of the plunger lever 430. The slide pin 450 includes a cylindrical rod 452 and a pin 454 positioned orthogonally to the rod 452 at an end of the rod 452. The pin 454 is sized to fit within the aperture 436 of the plunger lever 430. In certain exemplary embodiments, the cylindrical rod 452 is coupled to a pull knob (not shown) or cable (not shown) accessible to a user.

Each of the exemplary spike plungers 460 includes a base portion 462 having a square cross-section sized to fit within the square-shaped openings 414 on the inner ball 410. The spike plungers 460 also include spikes 464 on an end 466 thereof. In certain alternative embodiments, the spikes 464 are replaced by a knurled surface, or a series of divots or knob-like protrusions. On an end 468 opposite the end 466, the spike plungers 460 include an opening 470 having a biasing spring (not shown) disposed within. The openings 470 receive the first end 444a or the second end 444b of the slide rod 440. Each of the spike plungers 460 also includes a pin 474 extending from a side 476 of the spike plunger 460 adjacent to the end 468. The pins 474 are sized to engage the notches 432 of the plunger lever 430.

As seen in FIG. 4B the end 466 of the spike plunger 460 is aligned with the surface of the spherical portion 412 of the inner ball 410, and the spikes 464 protrude from the end 466 of the spike plunger 460. Furthermore, as seen in FIGS. 4C and 4D, the extension 446 (FIG. 4A) of the slide rod 440 is positioned within the aperture 434 (FIG. 4A) of the plunger lever 430. The pin 454 (FIG. 4A) of the slide pin 450 is positioned within the aperture 436 (FIG. 4A) of the plunger lever 430. The cylindrical rod 452 of the slide pin 450 partially extends into the cylindrical protrusion 416 of the inner ball 410. The first end 444a and the second end 444b of the slide rod 440 are positioned within the openings 470 in the spike plungers 460. The end 466 of the spike plungers 460 are positioned in the openings 414 of the inner ball 410. The outer ball assembly 420 surrounds the spherical portion 412 of the inner ball 410.

In the locked position, as shown in FIG. 4C, the plunger lever 430 is aligned with the cylindrical base 442 of the slide rod 440. The spikes 464 of the spike plungers 460 protrude from the inner ball 410 and grip the interior 420a of the outer ball assembly 420, thus locking the inner ball 410 in place within the outer ball assembly 420.

In the unlocked position, as shown in FIG. 4D, a user pulls on the pull knob (not shown) or cable (not shown), thus shifting the cylindrical rod 452 of the slide pin 450 away from the spherical portion 412 of the inner ball 410, and further into the cylindrical protrusion 416 of the inner ball 410. As a result, the plunger lever 430 rotates about the center 448 of the slide rod 440. Upon rotation of the plunger lever 430, the biasing springs are compressed within the openings 470 and the spike plungers 460 are pulled into the interior of the spherical portion 412, thus disengaging the spikes 464 from the outer ball assembly 420. Disengagement of the spikes 464 from the outer ball assembly 420 allows the outer ball assembly 420 to rotate freely with multiple degrees of freedom. In order to lock the ball-type mount system 400, the user simply releases the pull knob or cable. The biasing springs disposed in the openings 470 force the spike plungers 460 outwards into the locked position.

FIG. 4E is a perspective view of the exemplary ball-type mount system 400 of FIG. 4A-4D coupled to a worklight head 402 and mounted to a frame 404. The worklight head 402 includes a bracket 406 for releasable attachment to the outer ball assembly 420. In certain exemplary embodiments, the outer ball assembly 420 is provided with screw bosses projecting from the exterior 420b of the outer ball assembly 420. In certain embodiments, the screw bosses attach to features in the casting of the worklight housing or an additional bracket.

Upon unlocking the ball-type mount system 400, as described with respect to FIG. 4D, the outer ball assembly 420 is free to move, thereby allowing a user to adjust the worklight head 402 to a desired direction. Once adjusted, the user releases the pull knob or cable to lock the ball-type mount system 400 and prevent the worklight head 402 from shifting.

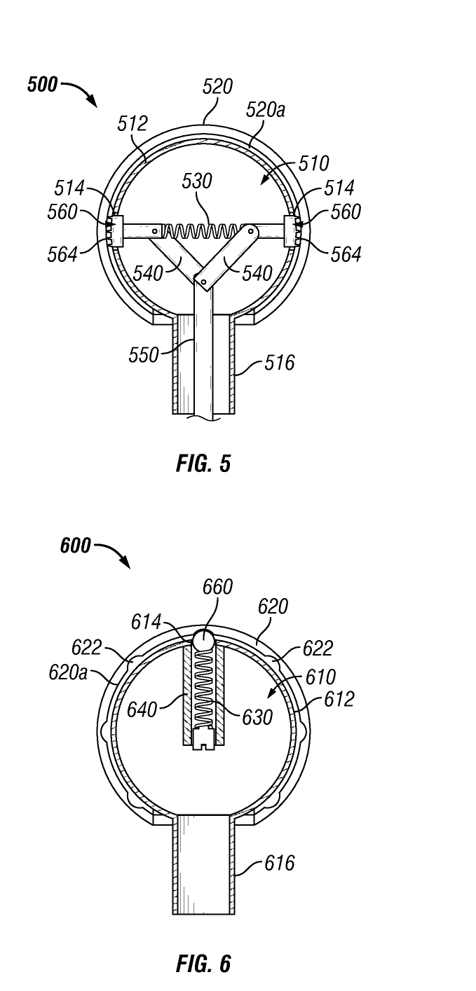

FIG. 5 is a cross-sectional view of another ball-type mount system 500 for a worklight assembly, according to another exemplary embodiment of the present invention. Referring now to FIG. 5, the ball-type mount system 500 is similar to the ball-type mount system 400 of FIG. 4A, the difference being in the mechanism by which the spike plungers 460 are retracted. The ball-type mount system 500 includes a hollow inner ball 510, similar to the hollow inner ball 410 of FIG. 4A. The inner ball 510 includes a spherical portion 512 and two square-shaped openings 514 positioned opposite one another on the spherical portion 512. The inner ball 510 also includes a hollow cylindrical protrusion 516 extending orthogonally outward from the inner ball 510 at a position between the openings 514. The ball-type mount system 500 also includes a hollow outer ball assembly 520, similar to the outer ball assembly 420 of FIG. 4A, and sized to fit around the inner ball 510.

The ball-type mount system 500 also includes a spring 530, two rods 540, a slide pin 550, and two spike plungers 560. The spike plungers are similar to the spike plungers 460 of FIG. 4A. The spring 530 is coupled to each of the spike plungers 560 and biases the spike plungers 560 away from each other. Each of the spike plungers 560 is also coupled to one of the rods 540. The rods 540 are movably coupled to the slide pin 550. In certain exemplary embodiments, the slide pin 550 is also coupled to a pull knob or a cable accessible to a user.

In the locked position, spikes 564 extending from the spike plungers 560 protrude from the inner ball 510 and grip an interior 520a of the outer ball assembly 520, thus locking the inner ball 510 in place within the outer ball assembly 520. In order to unlock the ball-type mount system 500, a user must pull on the pull knob or cable, thus shifting the slide pin 550 away from the spherical portion 512 of the inner ball 510, and further into the cylindrical protrusion 516 of the inner ball 510. As a result, the two rods 540 shift towards each other and the spring 530 is compressed. Upon compression of the spring 530, the spike plungers 560 are pulled into the interior of the spherical portion 512, thus disengaging the spikes 564 from the outer ball assembly 520. Disengagement of the spikes 564 from the outer ball assembly 520 allows the outer ball assembly 520 to rotate freely with multiple degrees of freedom. In order to lock the ball-type mount system 500, the user simply releases the pull knob or cable and the spring 530 biases the spike plungers 560 into the locked position.

FIG. 6 is a cross-sectional view of still another ball-type mount system 600 for a worklight assembly, according to yet another exemplary embodiment of the present invention. Referring to FIG. 6, the exemplary ball-type mount system 600 includes a hollow inner ball 610 that includes a spherical portion 612 and a cylindrical protrusion 616 extending orthogonally outward from the spherical portion 612. The inner ball 610 is similar to the inner ball 410 of FIG. 4A, the difference being that instead of the openings 414, the inner ball 610 includes a circular opening 614 opposite the cylindrical protrusion 616.

The exemplary ball-type mount system 600 includes a hollow outer ball assembly 620 sized to fit over the spherical portion 612. The outer ball assembly 620 is similar to the outer ball assembly 420 of FIG. 4A, the difference being that the outer ball assembly 620 includes a series of semi-circular recesses 622 spaced apart along an interior 620a of the outer ball assembly 620. The ball-type mount system 600 also includes a spring 630 housed within a cylindrical receptacle 640. The receptacle 640 extends from the opening 614 into the spherical portion 612. The ball-type mount system 600 further includes a ball bearing 660. In the locked position, the ball bearing 660 rests within the opening 614 between the spring 630 and one of the recesses 622. The spring 630 applies a locking force on the ball bearing 660, thus preventing the outer ball assembly 620 from rotating about the inner ball 610. In certain exemplary embodiments, a set screw (not shown) is included to increase the locking force of the spring 630 on the ball bearing 660. To unlock the ball-type mount system 600, a user applies sufficient force to overcome the locking force and move the outer ball assembly 620 so that the ball bearing 660 can engage another recess 622. In response, the user is able to adjust the direction of a worklight head (not shown) as desired.

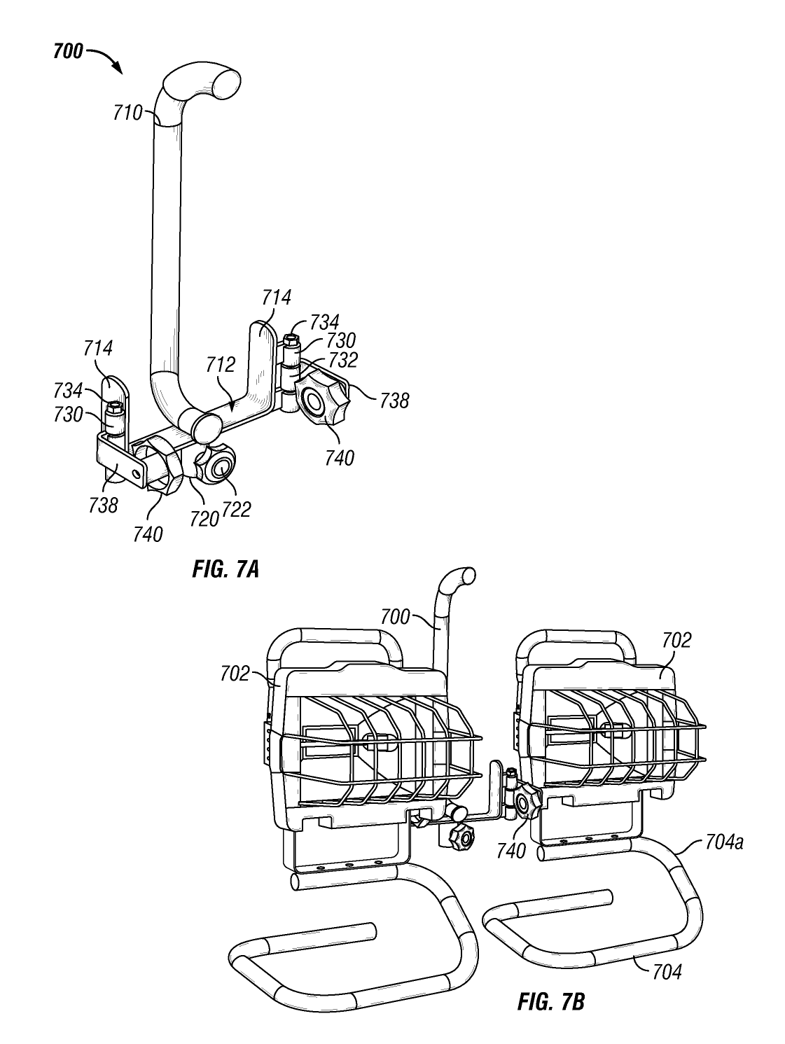

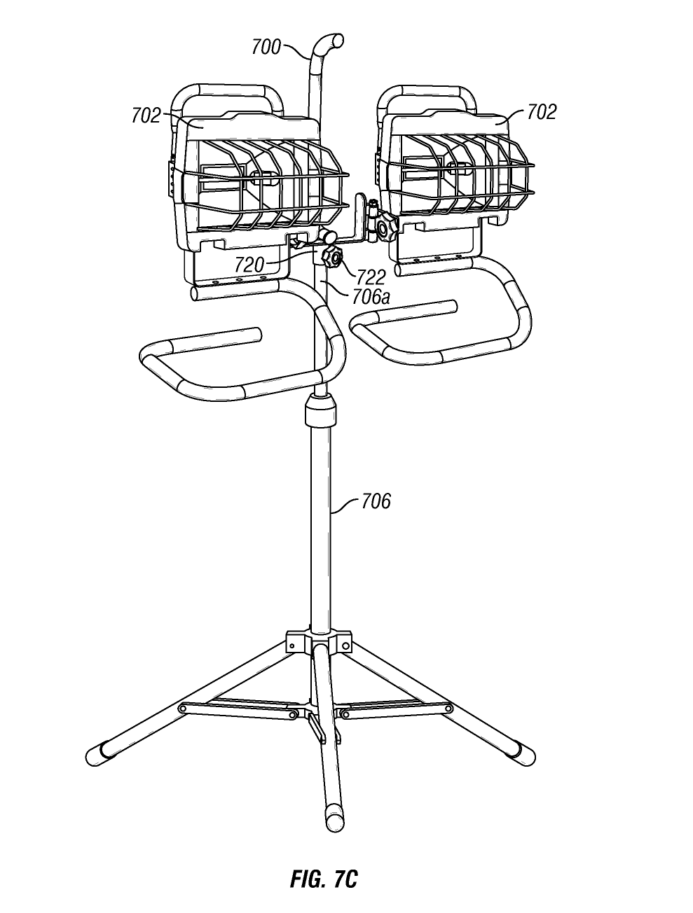

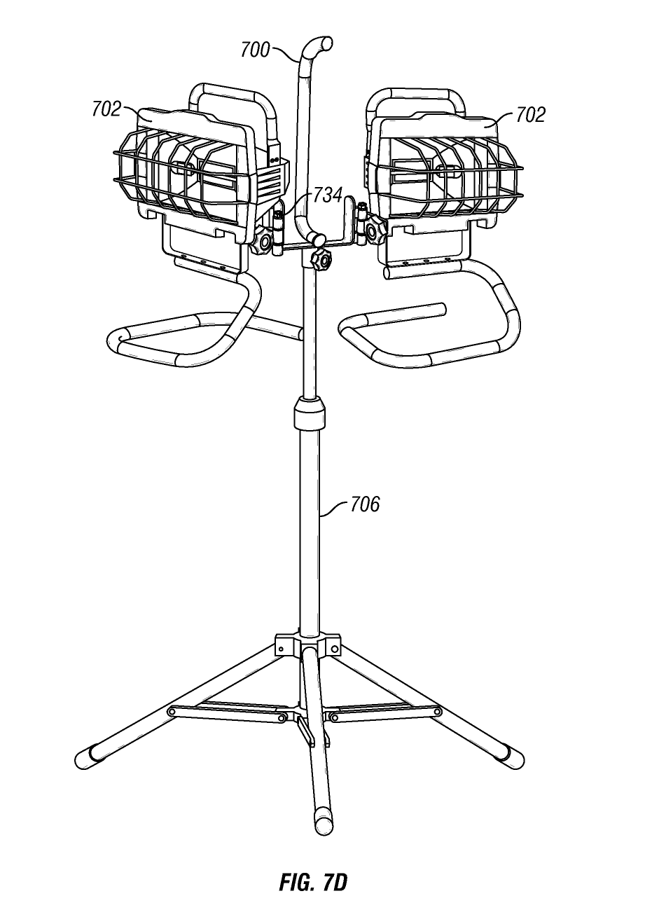

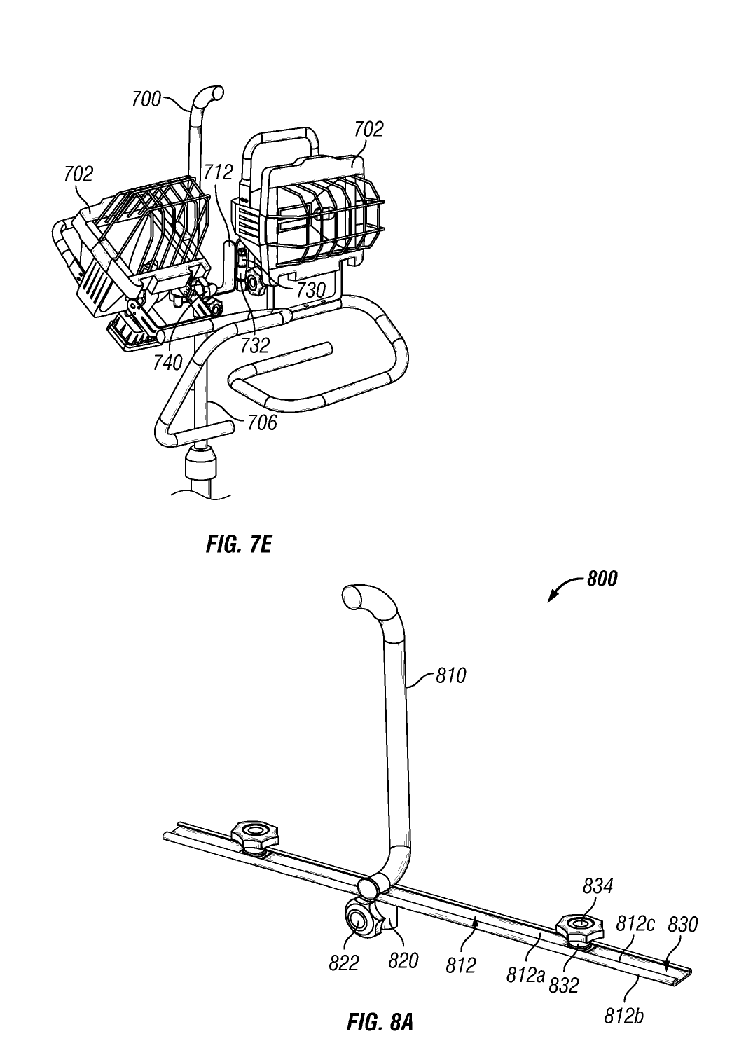

FIGS. 7A-7E are multiple views of a hinge and yoke system 700, according to an exemplary embodiment of the present invention. Turning to FIGS. 7A-7E, the exemplary hinge and yoke system 700 is configured to be coupled to two worklight heads 702. The hinge and yoke system 700 includes a handle 710 coupled to a bar 712. The bar 712 includes two flanges 714 extending from and orthogonal to the bar 712 at each end. A steel tube sleeve 720 for connecting to a tripod 706 is coupled to the bar 712 on a side opposite the handle 710. In one exemplary embodiment, the steel tube sleeve 720 is welded to the bar 712. In certain exemplary embodiments, the steel tube sleeve 720 includes a threaded knob 722 that goes into a threaded hole (not shown) in the sleeve 720 and secures the hinge and yoke system 700 to the tripod 706.

In one exemplary embodiment, each of the flanges 714 includes a fixed hinge portion 730 extending therefrom. The fixed hinge portion 730 is coupled to a movable hinge portion 732 by a removable hinge pin 734. Each of the movable hinge portions 732 includes a flange 738. Each of the flanges 738 includes a threaded knob 740 that goes into a threaded hole (not shown) in the worklight head 702 and secures the hinge and yoke system 700 to the worklight heads 702.

As seen in FIG. 7B, the worklight heads 702 are mounted to a top portion 704a of a stand 704. The stand 704 is similar to the stand 204 of FIG. 2A. The steel tube sleeve 720 receives shaft 706a of the tripod 706, and is secured in place by the threaded knob 722 that goes into a threaded hole in the sleeve 720. The exemplary worklight heads 702 as shown in FIG. 7C provide light in a same direction. However, as shown in FIG. 7D, one of the worklight heads 702 rotates about the hinge pin 734 so as to provide light in a direction different from the other worklight head 702. In addition, as shown in FIG. 7E, one or more of the worklight heads 702 are capable of being rotated upwards or downwards by loosening the threaded knob 740, adjusting the worklight head 702 to a desired direction, and then tightening the threaded knob 740 to secure the worklight head 702 in place.

The exemplary worklight heads 702 as shown and described in FIGS. 7A-7E, are able to have the same axis of rotation due to incorporation of the fixed hinge portion 730, movable hinge portion 732, and hinge pin 734 that are coupled to the bar 712 on either side. In addition, each of the worklight heads 702 can be removed from the hinge and yoke system 700 by removing the hinge pin 734 and disconnecting the fixed hinge portion 730 from the movable hinge portion 732. Therefore, each of the worklight heads 702 function as individual units outside of being mounted to the hinge and yoke system 700. As a result, instead of having to purchase a new tripod worklight unit when one of the worklight heads 702 becomes non-operational, an individual worklight head 702 is purchased to replace the broken worklight and save on the cost of a more expensive product. Another benefit of the present invention is that it provides the user with the ability to remove one individual worklight head 702 at a time, which allows for the use of just a single worklight head away from the tripod and/or yoke mount if that is all that is needed.

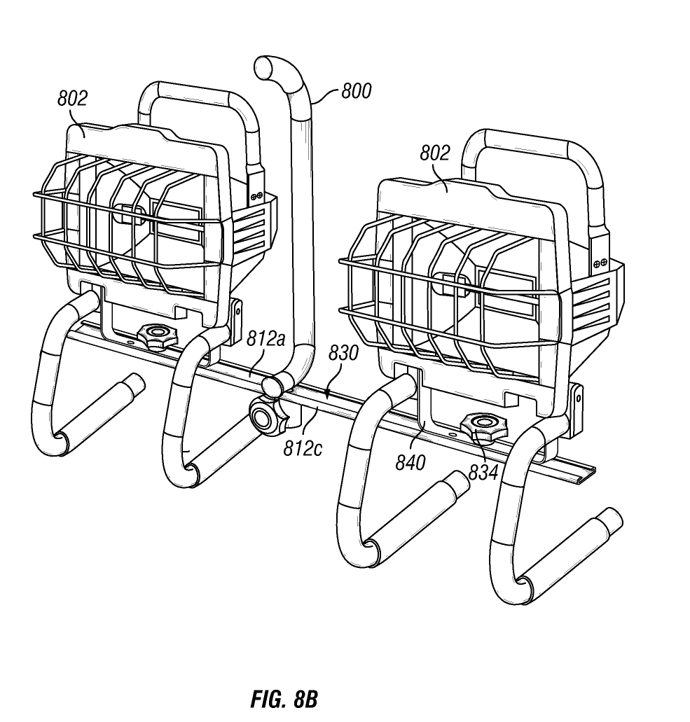

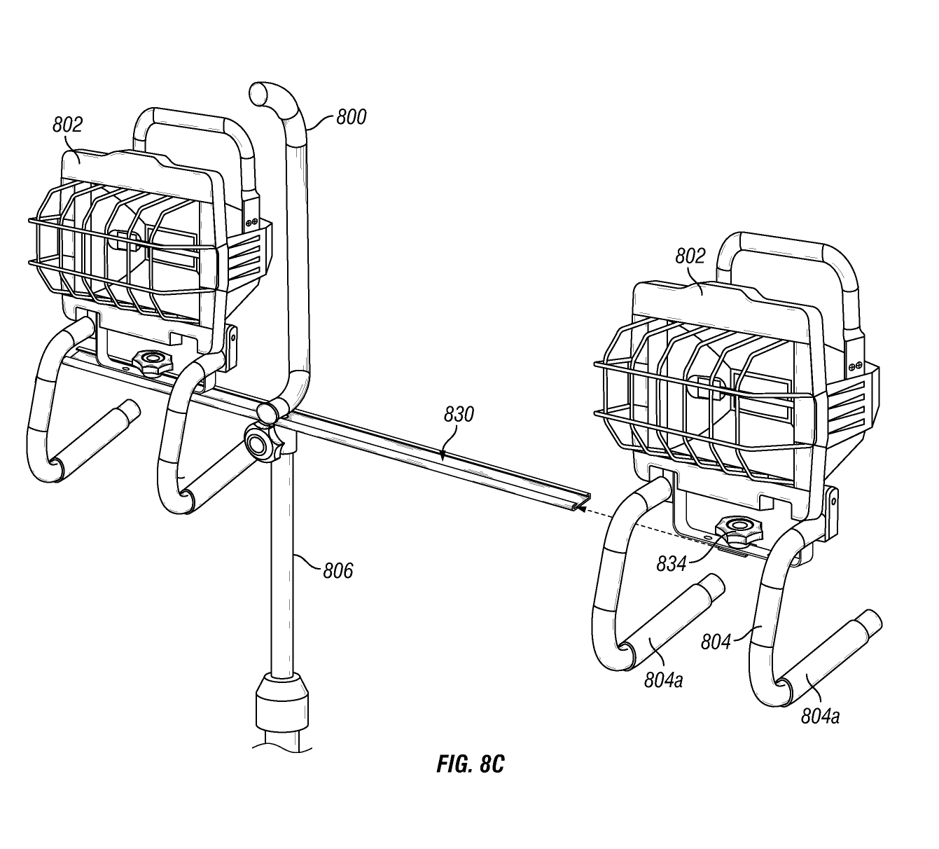

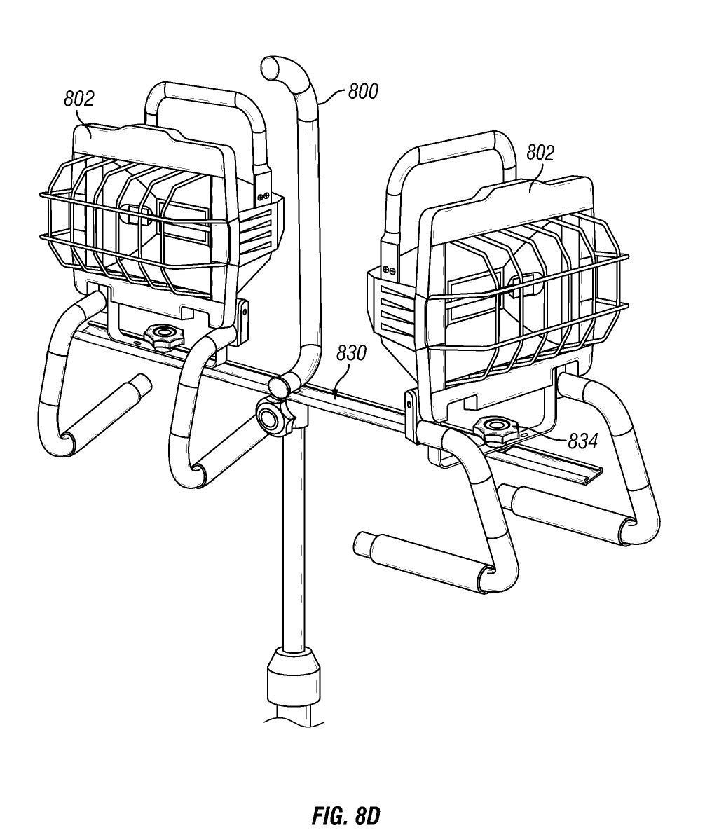

FIGS. 8A-8D present multiple views of a T-slot lock and yoke system 800, according to an exemplary embodiment of the present invention. Turning to FIGS. 8A-8D, the exemplary T-slot lock and yoke system 800 is configured to be coupled to two worklight heads 802. The T-slot lock and yoke system 800 includes a handle 810 coupled to a crossbar 812. A steel tube sleeve 820 for connecting to a tripod 806 (FIG. 8C) is welded to the crossbar 812 on a side opposite the handle 810. The steel tube sleeve 820 includes a threaded knob 822 that goes into a threaded hole (not shown) in the sleeve 820 and secures the T-slot lock and yoke system 800 to the tripod 806.

The crossbar 812 includes a flat surface 812a having two first extensions 812b extending orthogonally upwards. Two second extensions 812c extend orthogonally from the extensions 812b towards a centerline extending vertically from the flat surface 812a. The flat surface 812a, first extensions 812b, and second extensions 812c form a channel 830 for receiving a washer assembly 832. A threaded knob 834 goes into a threaded hole (not shown) in the washer assembly 832.

Each worklight head 802 includes a mounting bar 840. In one exemplary embodiment, the mounting bar 840 is sandwiched between the washer assembly 832 and the threaded knob 834 extending therethough. As the threaded knob 834 is tightened, the washer assembly 832 is forced upward along the threads (not shown) and applies an upward force against the second extensions 812c of the channel 830 and sandwiches at least a portion of the second extensions 812c between the washer assembly 832 and the mounting bar 840, while the bottom of the threaded rod 834 pushes against the flat surface 812a of the channel 830. This tightening of the threaded knob 834 holds the worklight heads 802 firmly in place.

To remove one of the worklight heads 802, the threaded knob 834 is loosened, causing the washer assembly 832 to move down the threaded knob 834 and reducing the force being applied by the washer assembly 832 to the second extensions 812c, thereby making washer assembly 832 free to move. The worklight head 802, and more particularly the washer assembly 832 then slides along and out of the channel 830. In certain exemplary embodiments, the worklight heads 802 are also coupled to a stand 804. In certain embodiments, the stand 804 includes two feet 804a that allow the worklight heads 802 to stand independently when removed from the channel 830.

In FIG. 8D, one of the worklight heads 802 is shown rotated 90 degrees and repositioned on the T-slot lock and yoke system 800 to direct light in a direction different from the other worklight head 802. The worklight head 802 is locked in place by tightening the threaded knob 834, and securing the washer assembly 832 (FIG. 8A) firmly within the channel 830.

Each of the worklight heads 802 function as individual units outside of being mounted to the T-slot lock and yoke system 800. Therefore, instead of having to purchase a new tripod worklight unit when one of the worklight heads 802 becomes non-operational, an individual worklight head 802 is purchased to replace the broken worklight and save on the cost of a more expensive product. Another benefit of the present invention is that it provides the ability to remove one individual worklight head 802 at a time, which allows for users to have just a single fixture if that is all that is needed separate from the tripod and/or yoke mount.

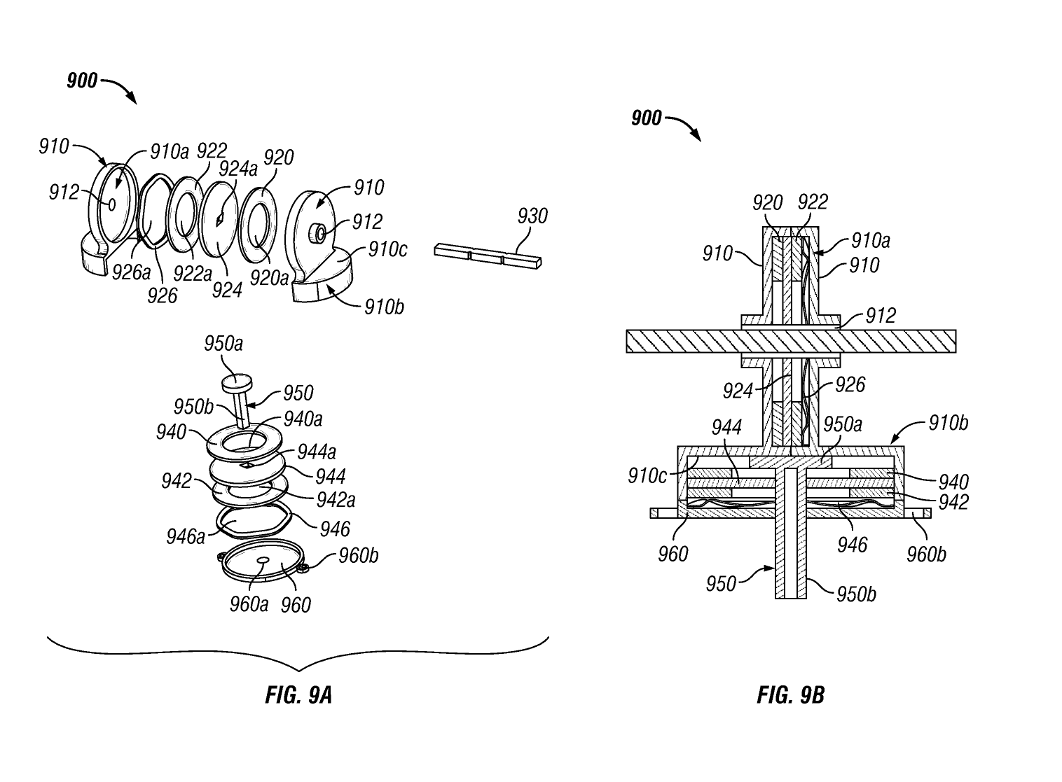

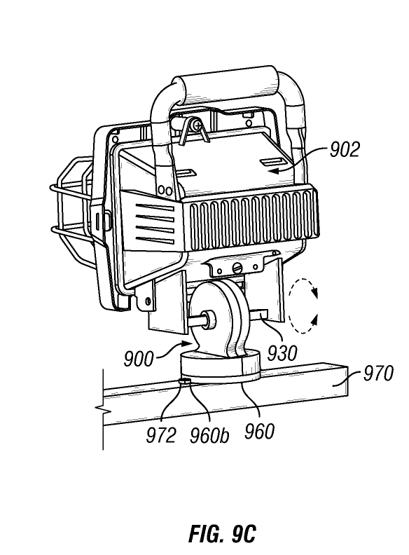

A multi-axis friction clutch allows for the adjustment and positioning of a worklight within a substantially 360 degree range of rotation. FIG. 9A is an exploded view of a multi-axis friction clutch 900 and FIG. 9B is a cross-sectional assembly view of the multi-axis friction clutch 900, each according to exemplary embodiments of the present invention. The multi-axis friction clutch 900 includes a two-piece clutch housing 910. When the two pieces of the clutch housing are assembled, the clutch housing 910 includes a cylindrical hollow top portion 910a coupled orthogonally to a cylindrical hollow bottom portion 910b open at one end. The top portion 910a includes an aperture 912 extending through a center of the top portion 910a.

The multi-axis friction clutch 900 includes two stationary disks 920 and 922, a rotatable disk 924, and a compressed wave washer 926 positioned within the top portion 910a of the clutch housing 910. The rotatable disk 924 is positioned between the two stationary disks 920 and 922. The wave washer 926 is adjacent the stationary disk 922. Each of the stationary disks 920, 922 includes an opening 920a, 922a, respectively, in a center thereof. The rotatable disk 924 includes a keyed opening 924a in a center thereof. The rotatable disk 924 is keyed to rotate with a rotatable shaft 930. The compressed wave washer 926 includes an opening 926a in a center thereof.

The multi-axis friction clutch 900 also includes the rotatable shaft 930 shaped to engage the keyed opening 924a of the rotatable disk 924. In certain alternative embodiments, the rotatable shaft 930 includes a nylon bushing (not shown) to hold the rotatable shaft 930 in place. The rotatable shaft 930 is positioned within the aperture 912 of the clutch housing 910, the opening 920a of the stationary disk 920, the opening 922a of the stationary disk 922, the keyed opening 924a of the rotatable disk 924, and the opening 926a of the wave washer 926. The stationary disks 920, 922 are held stationary relative to the clutch housing 910 by features (not shown) included in the clutch housing 910. In certain exemplary embodiments, sections of the clutch housing 910 include integrated ribs which lock into keyway features on the stationary disks 920, 922, and lock the disks stationary to the clutch housing 910. In alternative embodiments, a rod may be used in place of integral ribs to secure the stationary disks 920, 922 to the clutch housing 910. In certain exemplary embodiments, the stationary disks 920, 922, and the rotatable disk 924 are fabricated from acetal or steel.

The compressed wave washer 926 generates an axial holding force against the stationary disks 920, 922, and the rotatable disk 924, and keeps the rotatable disk 924 in a locked position. In certain alternative embodiments, the wave washer 926 is replaced by a Bellville washer or a compression spring.

The multi-axis friction clutch 900 also includes two stationary disks 940, 942, a rotatable disk 944, and a compressed wave washer 946 positioned within the bottom portion 910b of the clutch housing 910. The rotatable disk 944 is positioned between the two stationary disks 940, 942. The wave washer 946 is adjacent the stationary disk 942. A clutch cap 960 is coupled to the bottom portion 910b to encapsulate the stationary disks 940, 942, the rotatable disk 944, and the compressed wave washer 946 within the bottom portion 910b. The clutch cap 960 also includes attachment means 960b for affixing the multi-axis friction clutch 900 to a worklight frame 970, as shown in FIG. 9C. Each of the stationary disks 940, 942 includes an opening 940a, 942a, respectively, in a center thereof. The rotatable disk 944 includes a keyed opening 944a positioned in the center. In one exemplary embodiment, the rotatable disk 944 is keyed to rotate with a shaft 950b of a rotatable pin 950. The compressed wave washer 946 includes an opening 946a in a center thereof. The clutch cap 960 includes an opening 960a positioned in its center.

The multi-axis friction clutch 900 further includes the rotatable pin 950 having a head 950a and a shaft 950b shaped to engage the keyed opening 944a of the rotatable disk 944. The head 950a is positioned between the stationary disk 940 and a wall 910c of the bottom portion 910b. The shaft 950b is positioned within the opening 940a of the stationary disk 940, the opening 942a of the stationary disk 942, the keyed opening 944a of the rotatable disk 944, the opening 946a of the wave washer 946, and the opening 960a of the clutch cap 960. The stationary disks 940, 942 are held stationary relative to the clutch housing 910 by features (not shown) included in the clutch housing 910. In certain exemplary embodiments, sections of the clutch housing 910 include integrated ribs which lock into keyway features on the stationary disks 940, 942 and lock the disks 940, 942 stationary to the clutch housing 910. In alternative embodiments, a rod may be used in place of integral ribs to secure the stationary disks 940, 942 to the clutch housing 910. In certain exemplary embodiments, the stationary disks 940, 942, and the rotatable disk 944 are fabricated from acetal or steel.

In operation, the compressed wave washer 946 generates an axial holding force against the stationary disks 940, 942, and the rotatable disk 944, and keeps the rotatable disk 944 in a locked position. In certain alternative embodiments, the wave washer 946 is replaced by a Bellville washer or a compression spring.

Turning to FIG. 9C, the multi-axis friction clutch 900 is mounted to the worklight frame 970 by screws 972 extending through the attachment means 960b of the clutch cap 960. One having ordinary skill in the art will recognize that the multi-axis friction clutch 900 can be mounted to the worklight frame 970 in any number of ways. In one exemplary embodiment, the worklight 902 is coupled to the multi-axis friction clutch 900 by the rotatable shaft 930. Once mounted, the worklight 902 is turned left or right relative to the worklight frame 970 by applying enough force to overcome the holding force of the compressed wave washer 946 (FIG. 9A). The worklight 902 is also turned about the rotatable shaft 930 by applying enough force to overcome the holding force of the compressed wave washer 926 (FIG. 9A).

In certain alternative embodiments of the present invention, the rotatable disks 924, 944 are held in place by features in the clutch housing 910, thus eliminating the need for the rotatable shaft 930 or rotatable pin 950, respectively. In addition, alternative embodiments of the multi-axis friction clutch 900 include a knob (not shown) that allows a user to calibrate the holding force against the disks by tightening or loosening the knob.

As a result, the worklight 902 is directed to a desired direction without having to move or tilt an entire worklight fixture (not shown). The multi-axis friction clutch 900 of the present invention eliminates the need for adjusting knobs, where the user must take care in positioning the lamp, including over compensating lamp position as the knobs are being tightened. The exemplary multi-axis friction clutch 900 is also superior to conventional detent methods in that the multi-axis friction clutch 900 is not limited to specific angles of direction, depending on the allowable detent spacing. Instead, the exemplary multi-axis friction clutch 900 allows a substantially full 360 degree range of rotation in both the horizontal and vertical planes.

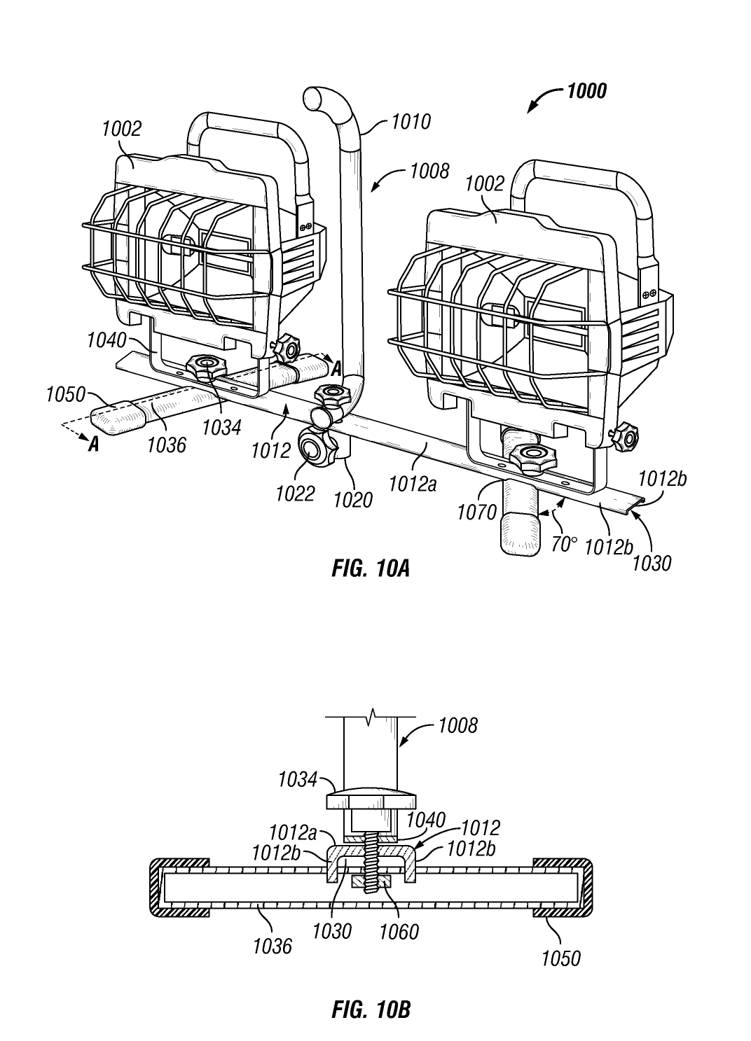

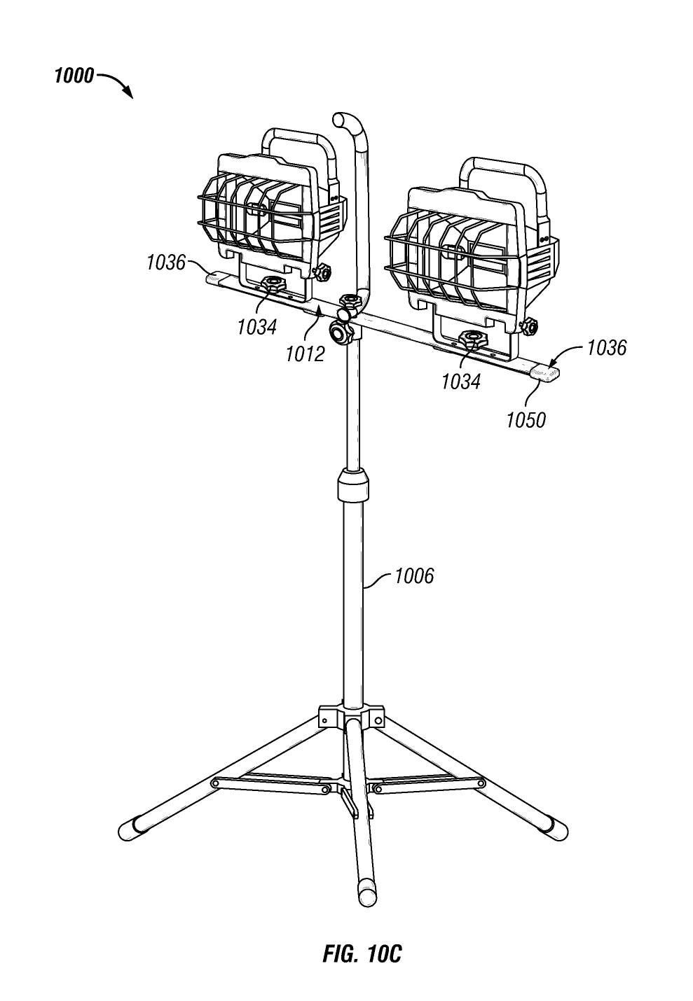

FIG. 10A is a perspective view of a worklight assembly 1000, according to an exemplary embodiment of the present invention. FIG. 10B is a cross-sectional view of section A-A of the exemplary worklight assembly 1000 shown in FIG. 10A. Referring to FIGS. 10A-10B, the worklight assembly 1000 includes two worklight heads 1002, each head 1002 providing lighting to a work area. Each of the worklight heads 1002 are mounted to a yoke system 1008. The yoke system 1008 includes a handle 1010 coupled to a crossbar 1012. The crossbar 1012 includes a flat surface 1012a having two extensions 1012b extending orthogonally therefrom in a direction away from the handle 1010. The flat surface 1012a and extensions 1012b form a C-shaped channel 1030 that is open along the bottom surface.

A steel tube sleeve 1020 for connecting to a tripod 1006 (FIG. 10B) is welded to the crossbar 1012 on a side opposite the handle 1010. The steel tube sleeve 1020 includes a threaded knob 1022 that is positionable within a threaded hole (not shown) in the sleeve 1020 and secures the yoke system 1008 to the tripod 1006.

Each worklight head 1002 also includes a mounting bar 1040 that is sandwiched between the flat surface 1012a of the crossbar 1012 and a threaded knob 1034 extending therethough. The threaded knob 1034 also secures a leg 1036 to each worklight head 1002 via a threaded nut 1060. In certain exemplary embodiments, the legs 1036 include rubber coverings, or feet, 1050. In certain exemplary embodiments, the legs 1036 are angled at a 70 degrees from the crossbar 1012. In certain alternative embodiments, the legs 1036 may be positioned at an angle in the range from about 0-180 degrees offset from the crossbar 1012. In certain exemplary embodiments, the crossbar 1012 has a pair of cutouts 1070 in each extension 1012b capable of receiving a portion of one of the legs 1036 so as to position the legs 1036 at an angle to the crossbar between 0-180 degrees. The legs 1036 provide stability and support for the worklight heads 1002 and the crossbar 1012 when placed on the ground or other surface.

FIG. 10C is a perspective view of the worklight assembly 1000 mounted to a tripod 1006. In this view, each leg 1036 of the worklight assembly 1000 is rotated to a desired position by loosening the threaded knobs 1034 and rotating the leg 1036. The legs 1036 are adjusted to be aligned with and disposed all or at least a portion within the C-shaped channel 1030 of the crossbar 1012. The threaded knobs 1034 are then tightened again to lock the legs 1036 in place within the C-shaped channel. In certain exemplary embodiments, the worklight leg are locked into place within the C-shaped channel by a clamping bolt. Thus, when the legs 1036 are in line with the C-shaped channel 1030 as shown, the present invention allows space to be saved at the worksite.

Generally, the features of the worklight assemblies of the present invention may decrease clutter and thus provide improved safety around a worksite, allow a user to adjust the direction of a worklight head as desired with more precision over conventional worklight assemblies, allow a user to remove one individual worklight head at a time if needed, allow a user substantially full 360 degree range of rotation of the worklight head in both horizontal and vertical planes, and/or minimize space occupied by worklight heads when mounted to a tripod. Therefore, the worklight assemblies of the present invention have improved capabilities over conventional worklight assemblies. Any spatial references herein, such as, for example, “top,” “bottom,” “upper,” “lower,” “above”, “below,” “rear,” “between,” “vertical,” “angular,” “beneath,” etc., are for purpose of illustration only and do not limit the specific orientation or location of the described structure.

Therefore, the invention is well adapted to attain the ends and advantages mentioned as well as those that are inherent therein. The particular embodiments disclosed above are illustrative only, as the invention may be modified and practiced in different but equivalent manners apparent to those having ordinary skill in the art and having the benefit of the teachings herein. While numerous changes may be made by those having ordinary skill in the art, such changes are encompassed within the spirit and scope of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A worklight assembly, comprising:
a worklight stand comprising:
a longitudinal shaft having a first end and a second end, the shaft extending in the vertical direction;
a plurality of legs coupled to the shaft and positioned adjacent to the first end; and
at least two power receptacles coupled to the worklight stand.

2. The worklight assembly of claim 1, wherein the at least two power receptacles are integral to the longitudinal shaft.

3. The worklight assembly of claim 1, wherein the at least two power receptacles are mounted to the longitudinal shaft by a collar coupled to the at least two power receptacles.

4. The worklight assembly of claim 1, further comprising:
at least one worklight disposed adjacent to the second end of the longitudinal shaft; and
a first power cable extending from one of the receptacles to the worklight head.

5. The worklight assembly of claim 1, further comprising:
a housing, wherein at least a portion of each of the power receptacles is disposed within the housing; and
a second power cable electrically coupled to the receptacles and coupled at one end to the housing and having a plug at an opposing end thereof.

6. A worklight assembly, comprising:
a worklight stand comprising:
a mounting shaft extending in the horizontal direction, a base portion positioned below the mounting shaft and extending in the horizontal direction, and a connector shaft coupling the mounting shaft to the base portion; and
at least two power receptacles coupled to the worklight stand.

7. The worklight assembly of claim 6, wherein the at least two power receptacles are integral to the base portion.

8. The worklight assembly of claim 6, wherein the at least two power receptacles are mounted to the worklight stand by a collar coupled to the at least two power receptacles.

9. The worklight assembly of claim 6, further comprising:
at least one worklight disposed adjacent to the mounting shaft; and
a first power cable extending from one of the receptacles to the worklight head.

10. The worklight assembly of claim 6, further comprising:
a housing, wherein at least a portion of each of the power receptacles is disposed within the housing; and
a second power cable electrically coupled to the receptacles and coupled at one end to the housing and having a plug at an opposing end thereof.

11. An adjustable mounting system, comprising:
an outer casing having a substantially circular cross-section;
an inner housing comprising a substantially spherical portion; and
a locking mechanism positioned within the spherical portion of the inner housing and adjustable between a locked and a unlocked position,
wherein the locking mechanism engages the outer casing in the locked position and prevents movement of the spherical portion within the outer casing, and
wherein the locking mechanism disengages from the outer casing in the unlocked position and allows the outer casing to move along the surface of the spherical portion of the inner housing.

12. The adjustable mounting system of claim 11, further comprising a substantially cylindrical-shaped protrusion extending from the spherical portion.

13. The adjustable mounting system of claim 11, wherein the inner housing comprises two openings configured to receive a locking means of the locking mechanism.

14. The adjustable mounting system of claim 13, wherein the locking means comprises at least one selected from the group consisting of spikes, knurled surfaces, ball bearings, divots, and protrusions.

15. The adjustable mounting system of claim 11, wherein the outer casing comprises a conformal coating on an interior surface of the outer casing.

16. The adjustable mounting system of claim 11, wherein the locking mechanism comprises:
a plunger lever comprising:
two notches positioned opposite each other;
a first aperture positioned substantially in a center of the plunger lever, and
a second aperture positioned adjacent to the first aperture;
a slide rod comprising a base portion and a rod protrusion extending from a center thereof, wherein the rod protrusion engages the first aperture;
a slide pin comprising a shaft extending out of the spherical portion and a pin extension at an end thereof, wherein the pin extension engages the second aperture; and
a plurality of plungers, each plunger comprising a first end and a second end, wherein the first end comprises locking means protruding therefrom and the second end comprises a plunger pin that engages one of the notches on the plunger lever;
wherein shifting of the slide pin away from the spherical portion rotates the plunger lever such that the two plungers are pulled towards one another to release the outer casing from the inner housing.

17. The adjustable mounting system of claim 11, wherein the locking mechanism comprises:
a plurality of plungers, each plunger comprising a first end and a second end, wherein the first end comprises locking means protruding therefrom;
a spring coupled to and extending from each of the second ends of the plungers, wherein the spring biases the plungers away from each other;
a plurality of rods coupled to the second ends of the plungers at a first end of the rods; and
a slide pin pivotally coupled to the rods at a second end of each of the rods, the slide pin extending out of the spherical portion,
wherein shifting of the slide pin away from the spherical portion compresses the spring and pulls the plungers towards one another to release the outer casing from the inner housing.

18. The adjustable mounting system of claim 11, wherein the locking mechanism comprises:
an opening in the spherical portion of the inner housing;
a locking means positioned within the opening;
a spring housing contained within the spherical portion of the inner housing and in communication with the opening; and
a spring positioned within the spring housing and in contact with the locking means,
wherein compression of the spring allows the locking means to shift partially into the spring housing to release the outer casing from the inner housing.

19. The adjustable mounting system of claim 18, wherein the outer casing comprises at least two recesses that receive the locking means.

20. A worklight support system, comprising:
a horizontally extending longitudinal bar having a first end and a second end;
a first flange coupled adjacent to and extending from the first end of bar;
a first hinge coupled to the first flange; and
a first mounting plate rotatably coupled to the first hinge, wherein the first mounting plate is movable relative to the first flange.

21. The worklight support system of claim 20, further comprising:
a second flange coupled adjacent to and extending from the second end of the bar;
a second hinge coupled to the second flange; and
a second mounting plate rotatably coupled to the second hinge, wherein the second mounting plate is movable relative to the second flange.

22. The worklight support system of claim 21, wherein each of the first and second flanges extend in a substantially orthogonal direction from the horizontally extending longitudinal bar, and wherein the first hinge and second hinge each rotate about a vertical axis.

23. The worklight support system of claim 20, further comprising a handle coupled to the bar and extending orthogonally from the bar.

24. The worklight support system of claim 20, wherein the first mounting plate is releasably coupled to a worklight

25. A worklight support system, comprising:
a mounting assembly releasably coupled to a worklight;
a horizontally disposed longitudinally extending bar comprising a channel disposed in and substantially along the length of the bar, wherein the channel is dimensioned to receive a plurality of the mounting assemblies and wherein at least a portion of each mounting assembly is dimensioned to be slidably received within the channel; and
a handle coupled to the bar and extending orthogonally from the bar.

26. The worklight support system of claim 25, wherein the mounting assembly comprises a washer assembly and a threaded knob, wherein the washer assembly is slidably received within the channel along a substantially horizontal path; wherein upon slidable insertion of the washer assembly into the channel, the washer assembly is vertically contained within the channel; and
upon tightening of the threaded knob, a portion of the channel is forcibly held between a portion of the washer assembly and an adjacent portion of the mounting assembly for the worklight. to lock the mounting assembly in place.

27. The worklight support system of claim 25, wherein the channel is a C-shaped channel having an open section disposed away from the handle and wherein the channel is configured to receive a worklight leg.

28. An adjustable mounting system for a worklight, comprising:
a clutch housing having a first cavity;
a plurality of first stationary disks positioned within the first cavity;
a first rotatable disk positioned between at least two of first stationary disks;
a first compressible disk positioned adjacent one of the first stationary disks and a first wall of the clutch housing; and
a first shaft extending through the clutch housing, first stationary disks, first rotatable disk, and first compressible disk;
wherein the first rotatable disk engages the first shaft; and
wherein the first compressible disk exerts a holding force that prevents the first rotatable disk from moving independently without the application of a force.

29. The adjustable mounting system of claim 28, wherein the first compressible disk is selected from the group consisting of compressed wave washers, Bellville washers, and compression springs.

30. The adjustable mounting system of claim 28, further comprising:
a second cavity orthogonal to the first cavity of the clutch housing;
a plurality of second stationary disks positioned within the second cavity;
a second rotatable disk positioned between at least two of the second stationary disks;
a second compressible disk positioned adjacent at least one of the second stationary disks and a second wall of the clutch housing; and
a second shaft extending through the clutch housing, second stationary disks, second rotatable disk, and second compressible disk;
wherein the second rotatable disk engages the second shaft; and
wherein the second compressible disk exerts a holding force that prevents the second rotatable disk from moving independently without the application of a force.
